(19) United States
(12) Patent Application Publication
(10) Pub. No.: US 2021/0360118 A1
(43) Pub. Date: Nov. 18, 2021

(54) COMMUNICATION APPARATUS, IMAGING APPARATUS, CONTROL METHOD OF THE SAME, AND STORAGE MEDIUM

(71) Applicant: CANON KABUSHIKI KAISHA, Tokyo (JP)

(72) Inventors: Jun Otsuki, Kanagawa (JP); Naoyuki Tsubaki, Tokyo (JP)

(21) Appl. No.: 17/306,749

(22) Filed: May 3, 2021

(30) Foreign Application Priority Data
May 15, 2020 (JP) 2020-086121

(51) Int. Cl. H04N 1/00; H04N 1/333; G06F 1/324; G06F 1/3234

(52) U.S. Cl. CPC H04N 1/00904; H04N 1/00896; G06F 1/3284; G06F 1/324; H04N 1/33323

(57) ABSTRACT

A communication apparatus includes a communication unit, having operation modes including a first operation mode in which data communication is enabled and a second operation mode in which power consumption is lower than that in the first operation mode, configured to perform data communication with an opposed device, and a control unit configured to control switching between the operation modes of the communication unit, wherein the control unit controls a speed of communication, at a transition of the communication unit from the first operation mode to the second operation mode, between the communication unit and the opposed device to a predetermined communication speed or lower, then causes the communication unit to transition from the first operation mode to the second operation mode, and then stops clock supply to the communication unit.

### BACKGROUND

### Field of the Disclosure

The present disclosure relates to a communication apparatus, an imaging apparatus, a control method of the same, and a storage medium.

### Description of the Related Art

Among communication apparatuses capable of data communication with external devices, there is known a communication apparatus that includes a communication unit having operation modes including a normal operation mode where data communication is performed and a low power consumption mode where power consumption is lower than in the normal operation mode. Japanese Patent Application Laid-Open No. 2016-213703 discusses an apparatus that includes a communication unit having such a low power consumption mode and controls the normal operation mode and the low power consumption mode for the purpose of reducing power consumption.

### SUMMARY

According to an aspect of the present disclosure, a communication apparatus includes a communication unit, having operation modes including a first operation mode in which data communication is enabled and a second operation mode in which power consumption is lower than that in the first operation mode, configured to perform data communication with an opposed device, and a control unit configured to control switching between the operation modes of the communication unit, wherein the control unit controls a speed of communication, at a transition of the communication unit from the first operation mode to the second operation mode, between the communication unit and the opposed device to a predetermined communication speed or lower, then causes the communication unit to transition from the first operation mode to the second operation mode, and then stops clock supply to the communication unit.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a communication apparatus according to one or more aspects of the present disclosure.

FIG. 2 is a flowchart illustrating an operation example of the communication apparatus according to one or more aspects of the present disclosure.

FIG. 3 is a flowchart illustrating an operation example of a communication apparatus according to one or more aspects of the present disclosure a second exemplary embodiment.

FIG. 4 is a block diagram illustrating a configuration example of a communication apparatus according to one or more aspects of the present disclosure.

FIG. 5 is a flowchart illustrating an operation example of a communication apparatus according to one or more aspects of the present disclosure.

### DESCRIPTION OF THE EMBODIMENTS

Hereinafter, embodiments of the present disclosure will be described with reference to the drawings.

A communication apparatus according to the embodiments of the present disclosure described below has, as operation modes, a normal operation mode where data communication is enabled and a low power consumption mode where power consumption is lower than in the normal operation mode. In the communication apparatus switchable between the normal operation mode and the low power consumption mode, further reduction in power consumption can be expected if the clock supply to a controller related to communication control can be stopped during operation in the low power consumption mode.

The communication apparatus also supports two different communication speeds. The communication apparatus has a function to control switching between the operation modes with two communication speeds, i.e., a high-speed communication mode with high communication speed and a low-speed communication mode with low communication speed. When the communication apparatus in the high-speed communication mode transitions to the low power consumption mode, the communication apparatus transitions to the normal communication mode after a lapse of a predetermined time. After the transition to the normal operation mode, the communication apparatus transitions again to the low power consumption mode, so that the communication apparatus repeats the transition between the normal operation mode and the low power consumption mode. In the case of performing high-speed data communication, even after the transition to the low power consumption mode, the communication apparatus transitions to the normal operation mode to perform data communication on a regular basis in order to shorten the time from the issue of a start instruction for data communication to the start of data transfer. This is a process for preventing reduction in the transfer efficiency as much as possible in the high-speed communication mode to perform high-speed data communication, In this way, when the communication apparatus in the high-speed communication mode transitions to the low power consumption mode, a communication occurs with a device that is a communication partner in the normal operation mode. Thus, from the viewpoint of preventing the occurrence of a crash or false operation of the communication apparatus, the communication apparatus needs to provide clock supply to the controller even in the low power consumption mode.

On the other hand, in the low-speed communication mode, the communication apparatus does not transition to the normal operation mode after a lapse of a predetermined time in the low power consumption mode. Thus, the communication apparatus is allowed stop the clock supply to the controller after the transition to the low power consumption mode.

Thus, in the present exemplary embodiment, the communication apparatus transitions to the low power consumption mode and stops the clock supply to the controller, in a state where the communication apparatus is not required, after the transition to the low power consumption mode, to return to the normal operation mode on a regular basis. Performing such an appropriate control sequence improves the effect of power saving in the low power consumption mode.

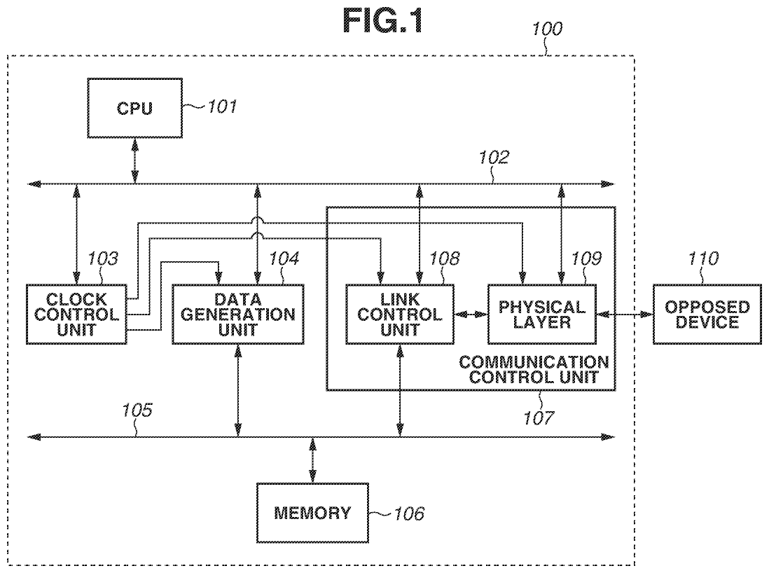

A first exemplary embodiment of the present disclosure will be described. FIG. 1 is a block diagram illustrating a configuration example of a communication apparatus 100 according to the first exemplary embodiment. The communication apparatus 100 includes a central processing unit (CPU) 101, a CPU bus 102, a clock control unit 103, a data generation unit 104, a memory bus 105, a memory 106, and a communication control unit 107.

The CPU 101 controls the functional units in the communication apparatus 100 via the CPU bus 102. The CPU 101 has a function to instruct the communication control unit 107 to perform mode control or communication speed control. The clock control unit 103 supplies a clock at a desired frequency to each of the functional units. The clock control unit 103 can also control the supply and stop of the clock to each of the functional units for each functional unit in response to an instruction from the CPU 101.

The data generation unit 104 has a function to generate data to be communicated to an opposed device (apparatus, chip, or the like), which is a counterpart device at the other end, that is opposed to the communication apparatus 100. The data generated by the data generation unit 104 is written into the memory 106 via, for example, the memory bus 105. The memory bus 105 is a bus that connects each of the communication units to the memory 106 and also serves as a memory controller that controls the memory 106 in the present exemplary embodiment. The memory 106 temporarily stores data processed by the functional units.

The communication control unit 107 has a function to control the communication function of the communication apparatus 100. The communication control unit 107 has an interface corresponding to two different communication speeds of the high communication speed in a high-speed communication mode and of a low communication speed in a low-speed communication mode. The communication apparatus 100 supports a normal operation mode in which data transfer is performed and the low power consumption mode, and can control switching between the two operation modes. The communication control unit 107 has a link control unit 108 and a physical layer 109.

The link control unit 108 is a link control unit (controller) in the communication control unit 107, and has internally a direct memory access (DMA) controller (not illustrated). For example, the link control unit 108 reads out data from the memory 106 via the memory bus 105 and sends the data to the physical layer 109 or writes data received from the physical layer 109 into the memory 106 via the memory bus 105,

The physical layer 109 has internally a logic circuit unit called physical coding sublayer (PCS) and an analog circuit called physical medium attachment (PMA), and has a function of inputting and outputting data to and from the opposed device 110. The opposed device 110 is a device that has an interface capable of communicating with the communication control unit 107, and can transmit and receive data to and from the communication apparatus 100 via a transmission path using the interface described above.

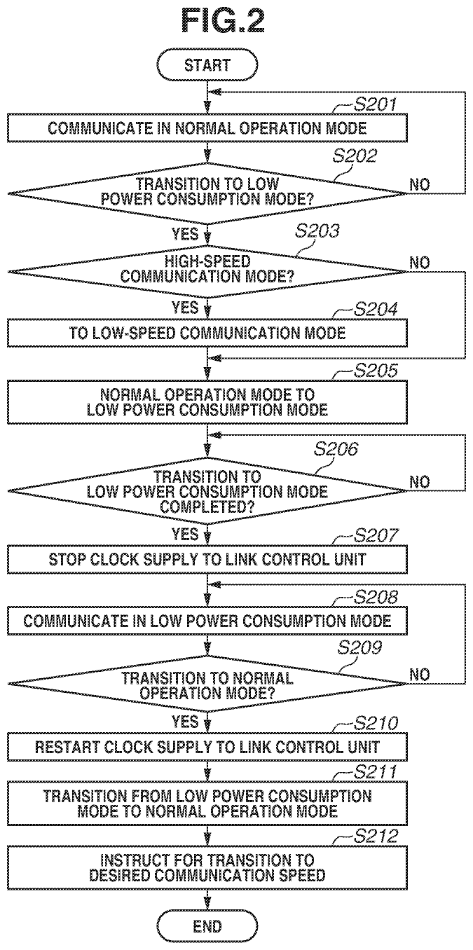

Next, a process for the transition from the normal operation mode to the low power consumption mode and the transition from the low power consumption mode to the normal operation mode in the communication apparatus 100 will be described with reference to a flowchart in FIG. 2. FIG. 2 is the flowchart illustrating an operation example of the communication apparatus 100 according to the first exemplary embodiment.

First, in step S201, the communication control unit 107 is performing data communication with the opposed device 110 in the normal operation mode.

In step S202, the communication control unit 107 determines whether the communication control unit 107 receives an instruction from the CPU 101 for a transition to the low power consumption mode. When the communication control unit 107 does not receive an instruction from the CPU 101 for a transition to the low power consumption mode (NO in step S202), the processing returns to step S201, and the communication control unit 107 continues the data communication in the normal operation mode. On the other hand, when the communication control unit 107 determines that the communication control unit 107 receives an instruction from the CPU 101 for a transition to the low power consumption mode (YES in step S202), the processing proceeds to step S203, In the communication apparatus 100 of the present exemplary embodiment, when no data communication is performed between the communication control unit 107 and the opposed device 110 for a predetermined time or more (e.g., 10 ms or more), the CPU 101 issues an instruction for a transition to the low power consumption mode.

In step S203, the CPU 101 determines whether the current speed of communication between the communication control unit 107 and the opposed device 110 corresponds to the high-speed communication mode. When the CPU 101 determines that the communication speed corresponds to the high-speed communication mode (YES in step S203), the processing proceeds to step S204. When the CPU 101 determines that the communication speed does not correspond to the high-speed communication mode (NO in step S203), the processing proceeds to step S205.

In step S204, the CPU 101 instructs the link control unit 108 in the communication control unit 107 to controls the communication speed mode to transition to the low-speed communication mode. In responses to the instruction from the CPU 101, the link control unit 108 controls the communication speed mode to transition to the low-speed communication mode to be a predetermined communication speed or less. Then, the processing proceeds to step S205.

In step S205, the CPU 101 controls the link control unit 108 to transition from the normal operation mode to the low power consumption mode. Under the control of the CPU 101, the link control unit 108 controls the communication with the opposed device 110 to transition to that in the low power consumption mode. After the control, the processing proceeds to step S206.

In step S206, the CPU 101 reads a register of the link control unit 108 and monitors the value in the register to determine whether the transition to the low power consumption mode has completed. The register read by the CPU 101 indicates the state of the device and usable for determining whether the current state is in the normal operation mode or the low power consumption mode. The CPU 101 repeats the processing in step S206 until it is determined that the transition to the low power consumption mode has completed. After the determination of the completion of the transition to the low power consumption mode, the processing proceeds to step S207.

In step S207, the CPU 101 instructs the clock control unit 103 to stop the clock supply to the link control unit 108. In response to the instruction from the CPU 101, the clock control unit 103 stops the clock supply to the link control unit 108.

In step S208, since the state of communication between the communication control unit 107 and the opposed device 110 is in the low power consumption mode and the clock supply to the link control unit 108 is stopped, a low power consumption state is maintained with a very low power consumption.

In step S209, the communication control unit 107 determines whether the CPU 101 has issued an instruction for a transition from the low power consumption mode to the normal operation mode. When the communication control unit 107 determines that the CPU 101 has not issued the instruction for a transition to the normal operation mode (NO in step S209), the processing returns to step S208 to maintain the low power consumption mode. On the other hand, when the communication control unit 107 determines that the communication control unit 107 has received an instruction from the CPU 101 for a transition to the normal operation mode (YES in step S209), the processing proceeds to step S210.

In step S210, the CPU 101 instructs the clock control unit 103 to restart the clock supply to the link control unit 108. In response to the instruction from the CPU 101, the clock control unit 103 restarts the clock supply to the link control unit 108.

In step S211, the CPU 101 controls the link control unit 108 to transition from the low power consumption mode to the normal operation code. Under the control of the CPU 101, the link control unit 108 controls an internal register of the opposed device 110 for the restarting the communication with the opposed device 110, thereby causing the communication between the communication control unit 107 and the opposed device 110 to transition to the normal operation mode. In this case, the communication speed comes to correspond to the normal operation mode in the low-speed communication mode.

In step S212, the CPU 101 controls the link control unit 108 to transition to a desired communication speed mode, for example, to the high-speed communication mode. The link control unit 108 controls the transition of the speed of communication with the opposed device 110 in response to the instruction from the CPU 101.

According to the control described above with reference to the flowchart illustrated in FIG. 2, the communication apparatus 100 performs the processing of transitioning from the normal operation mode to the low power consumption mode and of transitioning from the low power consumption mode to the normal operation mode. By performing such an appropriate control sequence, the communication apparatus switchable between, as operation modes, the normal operation mode and the low power consumption mode can further reduce power consumption in the low power consumption mode.

In the present exemplary embodiment, the communication apparatus supports the two communication speeds. However, the communication apparatus may support three or more communication speeds.

Next, a second exemplary embodiment of the present disclosure will be described. If the opposed device 110 can control the operation modes for communication between the communication apparatus 100 and the opposed device 110, the clock supply to the link control unit 108 cannot be stopped. In the second exemplary embodiment described below, the control is changed depending on whether an opposed device 110 can control the operation modes for communication between a communication apparatus 100 and an opposed device 110. In the second exemplary embodiment, a configuration of the communication apparatus 100 is similar to that of the communication apparatus 100 in the first exemplary embodiment illustrated in FIG. 1, and thus description of the configuration will be omitted.

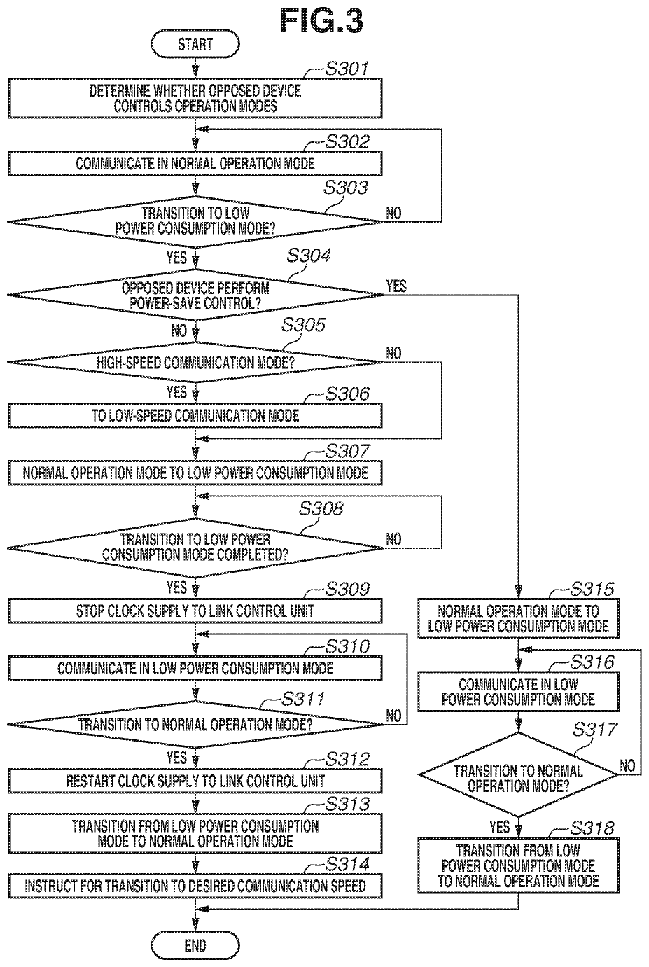

Next, processing of transitioning from the normal operation mode to the low power consumption mode and of transitioning from the low power consumption mode to the normal operation mode in the communication apparatus 100 will be described with reference to the flowchart in FIG. 3. FIG. 3 is the flowchart illustrating an operation example of the communication apparatus 100 in the second exemplary embodiment.

First, in step S301, a communication control unit 107 determines based on information on the register of the opposed device 110 whether the opposed device 110 controls the operation modes, and stores the information in the internal register of the communication control unit 107. The control of the operation modes refers to controlling transitions between the normal operation mode and the low power consumption mode described above.

Next, in step S302, the communication control unit 107 is performing data communication with the opposed device 110 in the normal operation mode.

In step S303, a communication control unit 107 determines whether a communication control unit 107 has received an instruction from a CPU 101 for a transition to the low power consumption mode. If the communication control unit 107 determines that the communication control unit 107 has not received the instruction for a transition to the low power consumption mode (NO in step S303), the processing returns to step S302, and the communication control unit 107 continues the data communication in the normal operation mode. On the other hand, when the communication control unit 107 determines that the communication control unit 107 has received an instruction for a transition to the low power consumption mode (YES in step S303), the processing proceeds to step S304. Also, in the present exemplary embodiment, if no data communication is performed between the communication control unit 107 and the opposed device 110 for a predetermined time or more (e.g., 10 ms or more), the CPU 101 issues an instruction for a transition to the low power consumption mode.

In step S304, the CPU 101 determines whether the opposed device 110 controls the operation modes, based on the information stored in the internal register by the communication control unit 107 in step S301. When the CPU 101 determines that the opposed device 110 does not control the operation modes (NO in step S304), the processing proceeds to step S305. When the CPU 101 determines that the opposed device 110 controls the operation modes (YES in step S304), the processing proceeds to step S315.

In step S305, the CPU 101 determines whether the current speed of communication between the communication control unit 107 and the opposed device 110 corresponds to the high-speed communication mode. When the CPU 101 determines that the communication speed corresponds to the high-speed communication mode (YES in step S305), the processing proceeds to step S306. When the CPU 101 determines that the communication speed does not correspond to the high-speed communication mode (NO in step S305), the processing proceeds to step S307.

In step S306, the CPU 101 instructs the link control unit 108 in the communication control unit 107 to cause the communication speed mode to transition to the low-speed communication mode. In response to the instruction from the CPU 101, the link control unit 108 controls the communication speed mode to transition to the low-speed communication mode to be a predetermined communication speed or less. Then, the processing proceeds to step S307.

In step S307, the CPU 101 controls the link control unit 108 to transition from the normal operation mode to the low power consumption mode. Under the control of the CPU 101, the link control unit 108 controls the communication with the opposed device 110 to transition to that in the low power consumption mode. After the control, the processing proceeds to step S308.

In step S308, the CPU 101 reads a register of the link control unit 108 and monitors the value in the register to determine whether the transition to the low power consumption mode has completed. The register read by the CPU 101 indicates the state of the device and is usable for determining whether the current state is in the normal operation mode or the low power consumption mode. The CPU 101 repeats step S308 until determining that the transition to the low power consumption mode has completed. After the determining the completion of the transition to the low power consumption mode, the processing proceeds to step S309.

In step S309, the CPU 101 instructs the clock control unit 103 to stop the clock supply to the link control unit 108. In response to the instruction from the CPU 101, the clock control unit 103 stops the clock supply to the link control unit 108.

In step S310, since the state of communication between the communication control unit 107 and the opposed device 110 is in the low power consumption mode and the clock supply to the link control unit 108 is stopped, a low power consumption state is maintained with a very low power consumption.

In step S311, the communication control unit 107 determines whether the communication control unit 107 has received an instruction from the CPU 101 for a transition from the low power consumption mode to the normal operation mode. When the communication control unit 107 determines that the communication control unit 107 has not received an instruction from the CPU 101 for a transition to the normal operation mode (No in step S311), the process returns to step S310 to maintain the low power consumption mode. On the other hand, when the communication control unit 107 determines that the communication control unit 107 has received the instruction from the CPU 101 for a transition to the normal operation mode (YES in step S311), the processing proceeds to step S312.

In step S312, the CPU 101 instructs the clock control unit 103 to restart the clock supply to the link control unit 108. In response to the instruction from the CPU 101, the clock control unit 103 restarts the clock supply to the link control unit 108.

In step S313, the CPU 101 controls the link control unit 108 to transition from the low power consumption mode to the normal operation mode. Under the control of the CPU 101, the link control unit 108 controls an internal register of the opposed device 110 to restart the communication with the opposed device 110, thereby causing the communication between the communication control unit 107 and the opposed device 110 to transition to the normal operation mode. In this case, the communication speed comes to correspond to the normal operation mode in the low-speed communication mode.

In step S314, the CPU 101 controls the link control unit 108 to transition to a desired communication speed mode, for example, to the high-speed communication mode. The link control unit 108 controls the transition of the speed of communication with the opposed device 110 in response to the instruction from the CPU 101.

In step S315 to which the processing proceeds when the CPU 101 determines in step S304 that the opposed device 110 controls the operation modes, the CPU 101 controls the link control unit 108 to transition from the normal operation mode to the low power consumption mode. Under the control of the CPU 101, the link control unit 108 controls the communication with the opposed device 110 to transition to that in the low power consumption mode. After the control, the processing proceeds to step S316. In this case, since the clock supply to the link control unit 108 is not stopped after the transition to the low power consumption mode, the speed of communication between the communication control unit 107 and the opposed device 110 is not controlled.

In step S316, the state of communication between the communication control unit 107 and the opposed device 110 is maintained in the low power consumption mode. However, the clock supply to the link control unit 108 in the communication control unit 107 is continued without being stop.

In step S317, the communication control unit 107 determines whether the communication control unit 107 has received an instruction from the CPU 101 for a transition from the low power consumption mode to the normal operation mode. When the communication control unit 107 determines that the communication control unit 107 has not received an instruction from the CPU 101 for a transition to the normal operation mode (NO in step S317), the processing returns to step S316 to maintain the low power consumption mode. On the other hand, when the communication control unit 107 determines that the communication control unit 107 has received an instruction from the CPU 101 for a transition to the normal operation mode (YES in step S317), the processing proceeds to step S318.

In step S318, the CPU 101 controls the link control unit 108 to transition from the low power consumption mode to the normal operation mode. Under the control of the CPU 101, the link control unit 108 controls the internal register of the opposed device 110 to restart the communication with the opposed device 110, thereby causing the communication between the communication control unit 107 and the opposed device 110 to transition to the normal operation mode.

By the control described above with reference to the flowchart illustrated in FIG. 3, the communication apparatus 100 performs the processing of transitioning from the normal operation mode to the low power consumption mode and further, transitioning from the low power consumption mode to the normal operation mode. By performing such an appropriate control sequence, the communication apparatus switchable between, as operation modes, the normal operation mode and the low power consumption mode can further reduce power consumption in the low power consumption mode.

In the present exemplary embodiment, the communication apparatus supports the two communication speeds. However, the communication apparatus may support three or more communication speeds.

Next, a third exemplary embodiment of the present disclosure will be described. In the third exemplary embodiment described below, the above-described control relating to data communication and mode control in the first and second exemplary embodiment is applied to an imaging apparatus. In this case, the effect of power saving can be further improved by performing data communication only for a predetermined time and additionally applying the above-described technique to the time period from a change of the imaging mode by a user to the start of data communication with an opposed device.

However, the application of the exemplary embodiments to the imaging apparatus may cause degradation of imaging performance due to the stop of data communication during a transition to the normal operation mode in some imaging modes. For example, when the imaging mode is changed to a high-speed continuous imaging mode in which 20 images is captured per second, if the time necessary for a transition to the normal operation mode is 200 milliseconds, the data communication for four images may be stopped to decrease the total number of continuously captured images.

In view of such an issue, the imaging apparatus according to the third exemplary embodiment can improve the effect of power saving in the low power consumption mode while keeping the imaging performance by selecting a control sequence based on information about a change of the imaging mode.

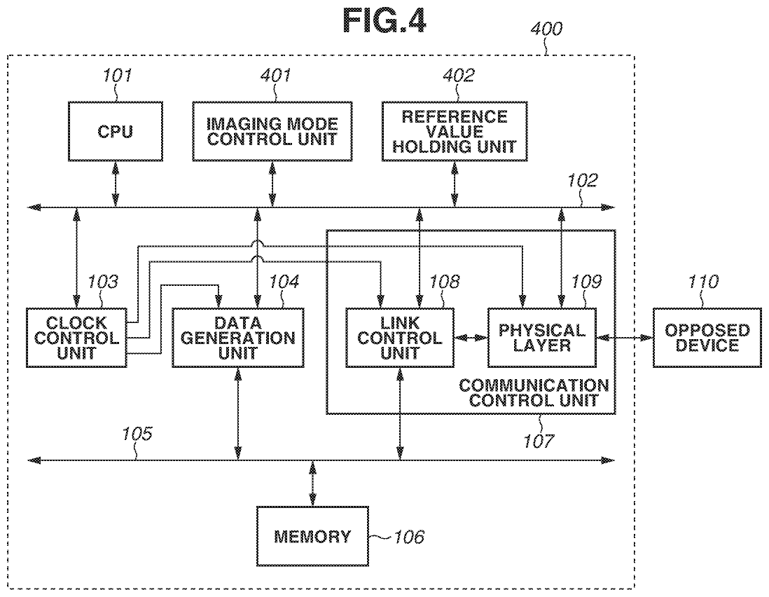

FIG. 4 is a block diagram illustrating a configuration example of an imaging apparatus 400 according to the third exemplary embodiment In FIG. 4, blocks having functions identical to those of the blocks illustrated in FIG. 1 are denoted with the reference numerals identical to those of the blocks illustrated in FIG. 1, and duplicated description of these blocks will be omitted. The imaging apparatus 400 has a CPU 101, a CPU bus 102, a clock control unit 103, a data generation unit 104, a memory bus 105, a memory 106, a communication control unit 107, an imaging mode control unit 401, and a reference value holding unit 402.

The imaging mode control unit 401 controls a change of an imaging mode and setting in accordance with instructions from a photographer. The imaging mode control unit 401 also has a function to transmit information on the changed imaging mode and settings to the CPU 101 via the CPU bus 102.

The reference value holding unit 402 holds information on the imaging mode and reference value that would cause degradation of imaging performance. The information on the imaging mode and reference value to be held is determined based on the results of preliminary measurement of the imaging performance, and is stored at the time of power on. The reference value holding unit 402 also has a function of transmitting the information on the imaging mode and reference value that would cause degradation of the imaging performance to the CPU 101 via the CPU bus 102.

The CPU 101 controls the functional units of the imaging apparatus 400 via the CPU bus 102. The CPU 101 also has a function of receiving the information on the imaging mode and the settings from the imaging mode control unit 401 and receiving the information on the imaging mode and the reference value that would cause degradation of the imaging performance from the reference value holding unit 402 via the CPU bus 102. The CPU 101 also has a function of instructing the communication control unit 107 to perform mode control or communication speed control. An opposed device 410 is a device that has an interface capable of communicating with the imaging apparatus 400, and can transmit and receive data to and from the imaging apparatus 400 through a transmission path using the interface.

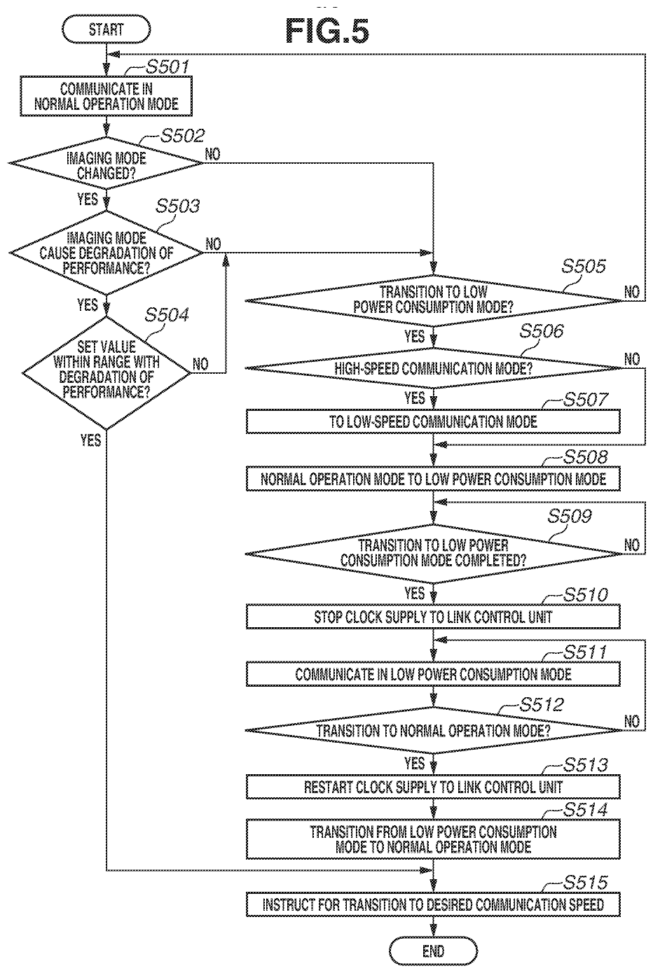

Next, processing of a transition from the normal operation mode to the low power consumption mode and a transition from the low power consumption mode to the normal operation mode in the imaging apparatus 400 based on the imaging mode will be described with reference to a flowchart in FIG. 5. FIG. 5 is the flowchart illustrating an operation example of the imaging apparatus 400 according to the third exemplary embodiment.

First, in step S501, the communication control unit 107 is performing data communication with the opposed device 410 in the normal operation mode.

In step S502, the CPU 101 determines information, from the imaging mode control unit 401, on the presence or absence of a change of the imaging mode, When the CPU 101 determines that the imaging mode has been changed (YES in step S502), the processing proceeds to step S503. When the CPU 101 determines that the imaging mode has not been changed (NO in step S502), the processing proceeds to step S505.

In step S503, the CPU 101 determines whether the current imaging mode is the imaging mode that would cause degradation of imaging performance, based on the information on the imaging mode from the imaging mode control unit 401 and the information on the imaging mode that would cause degradation of imaging performance from the reference value holding unit 402. When the CPU 101 determines that the current imaging mode is the imaging mode that would cause degradation of imaging performance (YES in step S503), the processing proceeds to step S504. When the CPU 101 determines that the current imaging mode is not the imaging mode that would cause degradation of imaging performance (NO in step S503), the processing proceeds to step S505.

In step S504, the CPU 101 determines whether the setting value that would cause degradation of imaging performance has been changed, based on the setting value from the imaging mode control unit 401 and the reference value from the reference value holding unit 402, When the CPU 101 determines that the setting value that would cause degradation of imaging performance has been changed (YES in step S504), the processing proceeds to step S515. When the CPU 101 determines that the setting value that would cause degradation of imaging performance has not been changed (NO in step S504), the processing proceeds to step S505.

In step S505, the communication control unit 107 determines whether the communication control unit 107 has received an instruction from the CPU 101 for a transition to the low power consumption mode. When the communication control unit 107 determines that the communication control unit 107 has not received an instruction for a transition to the low power consumption mode (NO in step S505), the processing returns to step S501, and the communication control unit 107 continues the data communication in the normal operation mode. On the other hand, when the communication control unit 107 determines that the communication control unit 107 has received an instruction for a transition to the low power consumption mode (YES in step S505), the processing proceeds to step S506. In the imaging apparatus 400 according to the present exemplary embodiment, when no data communication is performed between the communication control unit 107 and the opposed device 410 for a predetermined time or more (e.g., 10 ms or more), the CPU 101 issues an instruction for a transition to the low power consumption mode.

In step S506, the CPU 101 determines whether the current speed of communication between the communication control unit 107 and the opposed device 410 corresponds to the high-speed communication mode. When the CPU 101 determines that the communication speed corresponds to the high-speed communication mode (YES in step S506), the processing proceeds to step S507. When the CPU 101 determines that the communication speed does not correspond to the high-speed communication mode (NO in step S506), the processing proceeds to step S508.

In step S507, the CPU 101 instructs the link control unit 108 in the communication control unit 107 to control the communication speed mode to transition to the low-speed communication mode. In response to the instruction from the CPU 101, the link control unit 108 controls the communication speed mode to transition to the low-speed communication mode to be a predetermined communication speed or less. Then, the processing proceeds to step S508.

In step S508, the CPU 101 controls the link control unit 108 to transition from the normal operation mode to the low power consumption mode. Under the control of the CPU 101, the link control unit 108 controls the communication with the opposed device 410 to transition to the low power consumption mode. After the control, the processing proceeds to step S509.

In step S509, the CPU 101 reads a register of the link control unit 108 and monitors the value in the register to determine whether the transition to the low power consumption mode has completed. The register read by the CPU 101 indicates the state of the device and is usable for determining whether the current state is in the normal operation mode or the low power consumption mode. The CPU 101 repeats the processing in step S509 until it is determined that the transition to the low power consumption mode has completed. After determining the completion of the transition to the low power consumption mode, the processing proceeds to step S510.

In step S510, the CPU 101 instructs the clock control unit 103 to stop the clock supply to the link control unit 108. In response to the instruction from the CPU 101, the clock control unit 103 stops the clock supply to the link control unit 108.

In step S511, since the state of communication between the communication control unit 107 and the opposed device 410 is in the low power consumption mode and the clock supply to the link control unit 108 is stopped, a low power consumption state is maintained with a very low power consumption.

In step S512, the communication control unit 107 determines whether the communication control unit 107 has received an instruction from the CPU 101 for a transition from the low power consumption ode to the normal operation mode. When the communication control unit 107 determines that the communication control unit 107 has not received an instruction for a transition to the normal operation mode (NO in step S), the processing returns to step S510 to maintain the low power consumption mode. On the other hand, when the communication control unit 107 determines that the communication control unit 107 has received an instruction for a transition to the normal operation mode (YES in step S512), the processing proceeds to step S513.

In step S513, the CPU 101 instructs the clock control unit 103 to restart the clock supply to the link control unit 108. In response to the instruction from the CPU 101, the clock control unit 103 restarts the clock supply to the link control unit 108.

In step S514, the CPU 101 controls the link control unit 108 to transition from the low power consumption mode to the normal operation code. Under the control of the CPU 101, the link control unit 108 controls the internal register of the opposed device 410 to restart the communication with the opposed device 410, thereby causing the communication between the communication control unit 107 and the opposed device 410 to transition to the normal operation mode. The communication speed here comes to correspond to the normal operation mode in the low-speed communication mode.

In step S515. the CPU 101 controls the link control unit 108 to transition to a desired communication speed, for example, to the high-speed communication mode. The link control unit 108 controls the transition of the speed of communication with the opposed device 410 in response to the instruction from the CPU 101.

According to the control described above with reference to the flowchart illustrated in FIG. 5, the imaging apparatus 400 performs the processing of a transition from the normal operation mode to the low power consumption mode and of a transition from the low power consumption mode to the normal operation mode. By performing such an appropriate control sequence, it is possible to switch between the operation modes depending on the imaging mode, and further reduce power consumption in the low power consumption mode.

In the present exemplary embodiment, the imaging apparatus supports the two communication speeds. Further, the imaging apparatus may support three or more communication speeds.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Btu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-0186121, filed May 15, 2020, which is hereby incorporated by reference herein in its entirety.

What is claimed is:

1. A communication apparatus, comprising:
a communication unit, having operation modes including a first operation mode in which data communication is enabled and a second operation mode in which power consumption is lower than that in the first operation mode, configured to perform data communication with an opposed device; and
a control unit configured to control switching between the operation modes of the communication unit,
wherein the control unit controls a speed of communication, at a transition of the communication unit from the first operation mode to the second operation mode, between the communication unit and the opposed device to a predetermined communication speed or lower, then causes the communication unit to transition from the first operation mode to the second operation mode and then stops clock supply to the communication unit.

2. The communication apparatus according to claim 1, wherein the control unit causes the communication unit, when no data communication has not been performed between the communication unit and the opposed device for a predetermined time or longer, to transition from the first operation mode to the second operation mode.

3. The communication apparatus according to claim 1, wherein the predetermined communication speed is a communication speed at which, after the transition from the first operation mode to the second operation mode, the communication unit is not required to return to the first operation mode on a regular basis.

4. The communication apparatus according to claim 1, wherein the control unit stops clock supply, after the transition of the communication unit to the second operation mode, to a control unit in the communication unit.

5. An imaging apparatus, comprising:
an imaging mode control unit configured to control a change of an imaging mode and setting based on an instruction;
a communication unit, having operation modes including a first operation mode in which data communication is performed and a second operation mode in which power consumption is lower than that in the first operation mode, configured to perform data communication with an opposed device; and
a control unit configured to control switching between the operation modes of the communication unit,
wherein the control unit controls a speed of communication between the communication unit and the opposed device, in a case where the control unit determines that the change of the imaging mode will not cause degradation of imaging performance, at a transition of the communication unit from the first operation mode to the second operation mode, to a predetermined communication speed or lower, then controls the communication unit to transition from the first operation mode to the second operation mode, and stops clock supply to the communication unit.

6. The imaging apparatus according to claim 5, wherein the control unit determines whether the change of the imaging mode will cause degradation of imaging performance, based on information about the imaging mode and the setting to be changed and information about a predetermined imaging mode that will cause degradation of imaging performance and a reference value.

7. A control method of a communication apparatus including a communication unit, having operation modes including a first operation mode in which data communication is performed and a second operation mode in which power consumption is lower than that in the first operation mode, configured to perform data communication with an opposed device, the control method comprising:
controlling a speed of communication between the communication unit and the opposed device, at a transition of the operation mode of the communication unit from the first operation mode to the second operation mode, to a predetermined communication speed or lower;
causing the communication unit to transition from the first operation mode to the second operation mode; and
stopping clock supply to the communication unit.

8. The control method of a communication apparatus according to claim 7, wherein the communication unit is caused to transition, when no data communication has been performed between the communication unit and the opposed device for a predetermined time or longer, from the first operation mode to the second operation mode.

9. The control method of a communication apparatus according to claim 7, wherein the predetermined communication speed is a communication speed at which, after the transition from the first operation mode to the second operation mode, the communication unit is not required to return to the first operation mode on a regular basis.

10. The control method of a communication apparatus according to claim 7, wherein clock supply to a control unit in the communication unit is stopped after the transition of the communication unit to the second operation mode.

11. A control method of an imaging apparatus including a communication unit, having operation modes including a first operation mode in which data communication is performed and a second operation mode in which power consumption is lower than that in the first operation mode, configured to perform data communication with an opposed device, the control method comprising:
controlling a change of an imaging mode and setting in response to an instruction; and
controlling switching between the operation modes of the communication unit,
wherein, if it is determined that the change of the imaging mode will not cause degradation of imaging performance, at a transition of the communication unit from the first operation mode to the second operation mode, a speed of communication between the communication unit and the opposed device is controlled to a predetermined communication speed or lower, then the communication unit is caused to transition from the first operation mode to the second operation mode, and then clock supply to the communication unit is stopped.

12. The control method of an imaging apparatus according to claim 11, wherein it is determined whether the change of the imaging mode will cause degradation of imaging performance, based on information about the imaging mode to be changed and the setting and information about a predetermined imaging mode that will cause degradation of imaging performance and a reference value.

13. A non-transitory computer-readable storage medium storing a program for causing a computer in a communication apparatus including a communication unit, having operation modes including a first operation mode in which data communication is performed and a second operation mode in which power consumption is lower than that in the first operation mode, configured to perform data communication with an opposed device, to execute a method, the method comprising:
controlling, at a transition of the operation mode of the communication unit from the first operation mode to the second operation mode, a speed of communication between the communication unit and the opposed device to a predetermined communication speed or lower;
causing the communication unit, after the transition of the operation mode of the communication unit from the first operation mode to the second operation mode, to transition from the first operation mode to the second operation mode; and
stopping, after the transition from the first operation mode to the second operation mode a clock supply to the communication unit.

14. A non-transitory computer-readable storage medium storing a program for causing a computer in an imaging apparatus including a communication unit, having operation modes including a first operation mode in which data communication is performed and a second operation mode in which power consumption is lower than that in the first operation mode, configured to perform data communication with an opposed device, to execute a method, the method comprising:
controlling a change of an imaging mode and setting in response to an instruction; and
controlling switching between the operation modes of the communication unit,
wherein, if it is determined that the change of the imaging mode will not cause degradation of imaging performance, a speed of communication between the communication unit and the opposed device is controlled at a transition of the communication unit from the first operation mode to the second operation mode, to a predetermined communication speed or lower, then the communication unit is caused to transition from the first operation mode, to the second operation mode, and then clock supply to the communication unit is stopped.
